(19) United States
(12) Patent Application Publication
(10) Pub. No.: US 2026/0025885 A1
(43) Pub. Date: Jan. 22, 2026

(54) COOKING APPARATUS AND METHOD FOR CONTROLLING THE SAME

(71) Applicant: SAMSUNG ELECTRONICS CO., LTD., Suwon-si (KR)

(72) Inventors: Eunsu JANG, Suwon-si (KR); Daehyun KIM, Suwon-si (KR); Kyunghoon JUNG, Suwon-si (KR); Jiwoong CHOI, Suwon-si (KR); Hongjoo KANG, Suwon-si (KR); Kyounghwan KIM, Suwon-si (KR)

(73) Assignee: SAMSUNG ELECTRONICS CO., LTD., Suwon-si (KR)

(21) Appl. No.: 19/246,292

(22) Filed: Jun. 23, 2025

Related U.S. Application Data
(63) Continuation of application No. PCT/KR2025/095416, filed on Jun. 16, 2025.

(30) Foreign Application Priority Data
Jul. 22, 2024 (KR) 10-2024-0096738

(51) Int. Cl. H05B 6/06; H05B 6/12

(52) U.S. Cl. CPC H05B 6/065; H05B 6/1272; H05B 2213/05

(57) ABSTRACT

A cooking apparatus includes: a working coil; an inverter configured to drive the working coil; a current sensor configured to measure a resonant current flowing in the working coil as the working coil is driven by the inverter; and a controller configured to determine an equivalent inductance of an object heatable by the working coil while the object is above the working coil based on a magnitude of the resonant current measured by the current sensor, determine an equivalent resistance of the object based on a phase of the resonant current measured by the current sensor and the equivalent inductance, and control the inverter based on the equivalent inductance of the object, or based on the equivalent resistance of the object, or based on the equivalent inductance of the object and the equivalent resistance of the object.

### CROSS-REFERENCE TO RELATED APPLICATION

This application is a continuation application, under 35 U.S.C. § 111(a), of international application No. PCT/KR2025/095416, filed Jun. 16, 2025, which claims priority under 35 U.S.C. § 119 to Korean Patent Application No. 10-2024-0096738, filed Jul. 22, 2024, the disclosures of which are incorporated herein by reference in their entireties.

### TECHNICAL FIELD

The disclosure relates to a cooking apparatus able to estimate equivalent parameters and a method for controlling the same.

### BACKGROUND ART

A cooking apparatus is a device that includes a plate including a plurality of cooking zones on which cooking containers are placed, and a heating element for heating the cooking containers placed on the cooking zones to cook food inside the cooking container.

The cooking apparatus is a device for heating and cooking food, and generally is classified into an electric type cooking apparatus and a gas type cooking apparatus according to a heat source of the heating device. A gas stove uses the heat generated by burning gas as a heat source, and highlights use the heat generated by electric heaters as a heat source. Induction heaters may heat cooking containers using an induction heating principle.

An induction heater may include an induction heating coil that generates a magnetic field when current is applied as a heating element. Because the induction heater uses the cooking container itself as a heat source, the induction heater may have a high heat transfer rate without harmful gases and risk of fire, compared to a gas stove or a stove that burns fossil fuels and heats the cooking container through the combustion heat.

Recently, user convenience has been improved by providing a function to remotely control the heating element of the cooking apparatus.

### DISCLOSURE

### Technical Problem

The disclosure provides a cooking apparatus and a method for controlling the same that may accurately identify an equivalent inductance and an equivalent resistance of an object to be cooked.

The disclosure provides a cooking apparatus and a method for controlling the same that may accurately identify whether an object to be cooked is a foreign substance.

The disclosure provides a cooking apparatus and a method for controlling the same that may optimally control a working coil using an equivalent inductance and an equivalent resistance of an object to be cooked.

Technical aspects that can be achieved by the disclosure are not limited to the above-mentioned aspects, and other technical aspects not mentioned will be clearly understood by one of ordinary skill in the technical art to which the disclosure belongs from the following description.

### Technical Solution

According to an embodiment, a cooking apparatus may include: a working coil; an inverter configured to drive the working coil; a sensor configured to measure a resonant current flowing in the working coil as the working coil is driven by the inverter; and a controller configured to determine an equivalent inductance of an object heatable by the working coil while the object is above the working coil based on a magnitude of the resonant current measured by the current sensor, determine an equivalent resistance of the object based on a phase of the resonant current measured by the current sensor and the equivalent inductance, and control the driving of the working coil by the inverter based on the equivalent inductance of the object, or based on the equivalent resistance of the object, or based on the equivalent inductance of the object and the equivalent resistance of the object.

According to an embodiment, in a method for controlling a cooking apparatus including a working coil; an inverter configured to drive the working coil; and a sensor configured to measure a resonant current flowing in the working coil as the working coil is driven by the inverter, the method may include: determining an equivalent inductance of an object heatable by the working coil while the object is above the working coil based on a magnitude of the resonant current measured by the sensor; determining an equivalent resistance of the object based on a phase of the resonant current measured by the current sensor and the equivalent inductance; and controlling the driving of the working coil by the inverter based on the equivalent inductance of the object, or based on the equivalent resistance of the object, or based on the equivalent inductance of the object and the equivalent resistance of the object.

### DESCRIPTION OF DRAWINGS

FIG. 1A and FIG. 1B are perspective views of a cooking apparatus according to an embodiment, viewed from the top.

FIG. 2 illustrates a cooking apparatus that heats an object to be cooked according to an embodiment.

FIG. 3 and FIG. 4 illustrate examples of a coil driver circuit of a cooking apparatus according to an embodiment.

FIG. 5 is a block diagram illustrating an example configuration of a cooking apparatus according to an embodiment.

FIG. 6 is a flowchart illustrating an example of a method for controlling a cooking apparatus according to an embodiment.

FIG. 7 is a flowchart illustrating an example of an equivalent inductance estimation operation and an equivalent resistance estimation operation, in a method for controlling a cooking apparatus according to an embodiment.

FIG. 8 is a conceptual block diagram for performing an equivalent inductance estimation operation and an equivalent resistance estimation operation by a cooking apparatus according to an embodiment.

FIG. 9 is a flowchart illustrating a method of determining whether an object is a foreign substance, in a method for controlling a cooking apparatus according to an embodiment.

FIG. 10 is a flowchart illustrating a method for controlling an inverter to minimize a loss value, in a method for controlling a cooking apparatus according to an embodiment.

FIG. 11 is a flowchart illustrating a method for controlling a plurality of inverters to heat an object with maximum efficiency while minimizing noise generation, in a method for controlling a cooking apparatus according to an embodiment.

FIG. 12 is a flowchart illustrating a method for controlling a dual coil to heat an object with maximum efficiency, in a method for controlling a cooking apparatus according to an embodiment.

### MODES OF THE DISCLOSURE

Various embodiments and the terms used therein are not intended to limit the technology disclosed herein to specific forms, and the disclosure should be understood to include various modifications, equivalents, and/or alternatives to the corresponding embodiments.

Terms used herein are used only to describe particular embodiments and are not intended to limit the disclosure.

For example, it is to be understood that the singular forms are intended to include the plural forms as well, unless the context clearly dictates otherwise.

The expressions such as “A or B”, “at least one of A or/and B”, “one or more of A or/and B”, “A, B or C”, “at least one of A, B or/and C”, or “one or more of A, B or/and C”, and the like used herein may include any and all combinations of one or more of the associated listed items. For example, terminology such as “at least one of A, B, or C”, as used herein includes any of the following: “A”, “B”, “C”, “A and B”, “A and C”, “B and C”, “A and B and C”.

The term of “or” includes a plurality of combinations of relevant items or any one item among a plurality of relevant items. For example, “A or B” may include only “A”, only “B”, or both “A and B”.

The terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

The terms “front,” “rear,” “left,” “right,” “upper,” “lower,” etc., used in the following description are defined based on the drawings, and the shape and position of each component are not limited by these terms. For example, the front side may be defined as the +X side and the rear side may be defined as the-X side. For example, based on the drawings, the right side may be defined as the +Y side and the left side may be defined as the-Y side. For example, based on the drawings, the upper side may be defined as the +Z side and the lower side may be defined as the-Z side.

In addition, it will be understood that the terms “first”, “second”, etc., may be used only to distinguish one component from another, not intended to limit the corresponding component in other aspects.

Terms such as “unit”, “portion”, “block”, “member”, and “module” indicate a unit for processing at least one function or operation. For example, those terms may refer to at least one process processed by at least one hardware such as Field Programmable Gate Array (FPGA), Application Specific Integrated Circuit (ASIC), at least one software stored in a memory or a processor.

Embodiments of the disclosure will be described below in detail with reference to the accompanying drawings. Like reference numerals refer to like elements throughout the specification

Hereinafter, an operation principle and embodiments will be described below in detail with reference to the accompanying drawings.

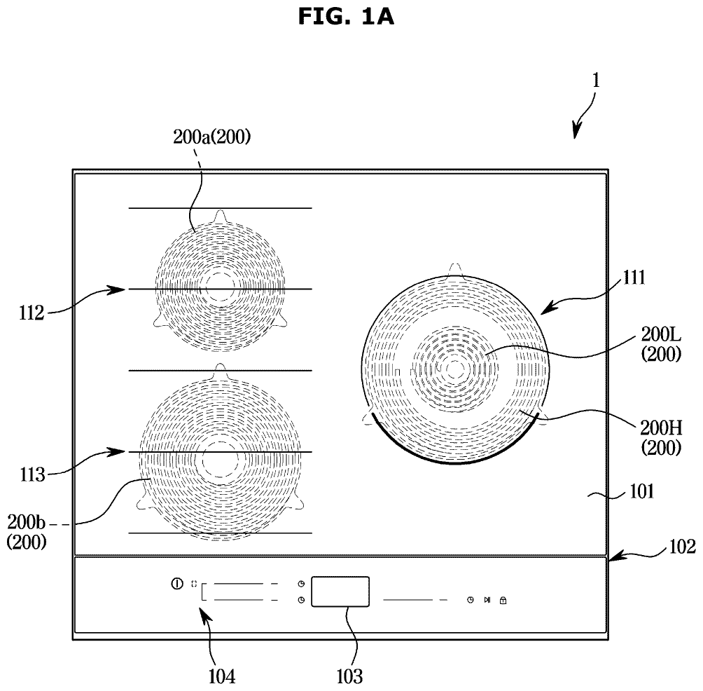

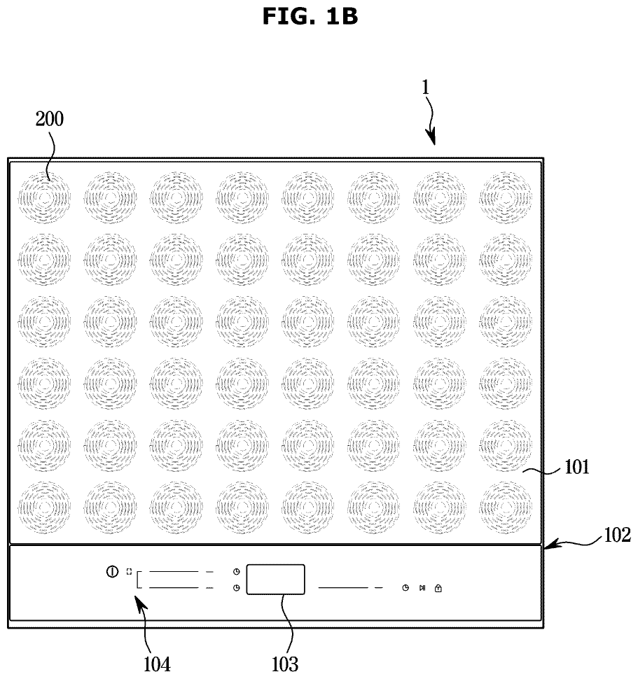

FIG. 1A and FIG. 1B are perspective views of a cooking apparatus according to an embodiment, viewed from the top.

Referring to FIG. 1A, a cooking apparatus 1 may include a plate 101 provided above a main body 102, cooking zones 111, 112, and 113 formed on the plate 101, and user interfaces 103 and 104 functioning as an input/output device. For example, the plate 101 may be made of ceramic.

The cooking zones 111, 112, and 113 indicate a position on which a cooking container is placed, and may be represented as a circular shape as shown in a reference numeral 111 or as straight lines as shown in reference numerals 112 and 113 to guide proper placement of the cooking container.

However, the shapes described above are only an example, and any shape may be applied to the embodiment of the cooking apparatus 1 as long as it may guide a user to a location of the cooking zone.

In addition, although it is illustrated in FIG. 1A that three cooking zones are formed on the plate 101 as an example, the embodiment of the cooking apparatus 1 is not limited thereto. That is, only one cooking zone or four or more cooking zones may be formed.

For example, referring to FIG. 1B, no separate cooking zone may be formed on the plate 101, and the entire plate 101 may function as a cooking zone.

A working coil 200 may be provided below the plate 101.

Referring to FIG. 1A, the working coil 200 corresponding to each of the cooking zones 111, 112, and 113 may be provided below each of the cooking zones 111, 112, and 113.

The working coil 200 may also be referred to as a heating element, a heating coil, and the like, in that the working coil 200 is used to heat an object to be cooked.

In the disclosure, the object to be cooked may be referred to as an object to be heated, a cooking container, etc.

The number of working coils 200 corresponding to the cooking zones 111, 112, and 113 may be plural.

For example, a plurality of first working coils 200L and 200H may be provided below the first cooking zone 111. The plurality of first working coils 200L and 200H may be two, and in this case, the plurality of first working coils 200L and 200H may be referred to as dual working coils 200L and 200H.

One (200L, hereinafter referred to as the ‘first dual coil’) of the dual working coils 200L and 200H may be located inside the other (200H, hereinafter referred to as the ‘second dual coil’) of the dual working coils 200L and 200H. A winding radius of the first dual coil 200L may be smaller than that of the second dual coil 200H. From this perspective, the first dual coil 200L and the second dual coil 200H may be referred to as an inner coil and an outer coil, respectively.

An output intensity of the first dual coil 200L may be greater than that of the second dual coil 200H. From this perspective, the first dual coil 200L and the second dual coil 200H may be referred to as a high output coil and a low output coil, respectively.

A second working coil 200a may be provided below the second cooking zone 112.

A third working coil 200b may be provided below the third cooking zone 113.

Because the second cooking zone 112 and the third cooking zone 113 are adjacent to each other, the second working coil 200a and the third working coil 200b may be provided adjacent to each other below the plate 101.

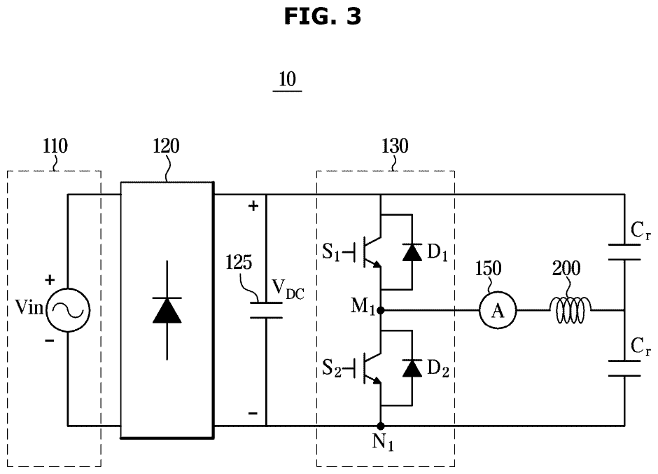

As described below, the cooking apparatus 1 may include a plurality of coil driver circuits (10, see FIGS. 3, 4, and 5) for driving the plurality of working coils 200.

Each of the plurality of coil driver circuits 10 may drive at least one of the plurality of working coils 200.

Referring to FIG. 1B, the plurality of working coils 200 may be provided below the plate 101.

No separate cooking zone may be formed on the plate 101.

According to an embodiment, the cooking apparatus 1 may identify a location where an object to be cooked (hereinafter referred to as the “object”) is placed on the plate 101 through various sensors (e.g., capacitance sensors), and may identify the working coils (or working coils capable of heating the object) corresponding to the location where the object is placed among the plurality of working coils.

The cooking apparatus 1 may heat the object placed at a predetermined position on the plate 101 by driving the working coils capable of heating the object.

The cooking apparatus 1 shown in FIG. 1B may be referred to as an any-place cooking apparatus in that the object may be placed anywhere on the plate 101.

As described above, the cooking apparatus 1 may include the plurality of coil driver circuits (10, see FIGS. 3, 4, and 5) for driving the plurality of working coils 200.

Referring to FIG. 1A and FIG. 1B, an output device 103 and an input device 104 may be provided in one area of the plate 101.

The output device 103 may output sensory information (e.g., visual information and/or auditory information). For example, the output device 103 may include a display and/or a speaker.

The display may include a display such as a liquid crystal display (LCD) or a light emitting diode (LED).

The input device 104 may receive user input from a user. Here, the user input may include tactile input and/or auditory input.

The input device 104 may include at least one of various input devices, such as a microphone, a touch pad, a button, a jog shuttle, etc. Alternatively, the output device 103 and the input device 104 may be implemented as a touch screen.

It is illustrated that the output device 103 and the input device 104 are spaced apart from the cooking zones 111, 112, and 113 on the plate 101 as an example. However, the arrangements shown in FIG. 1A and FIG. 1B is only an example applicable to the cooking apparatus 1, and the output device 103 and the input device 104 may be provided in a location other than on the plate 101, such as a front side of the cooking apparatus 1.

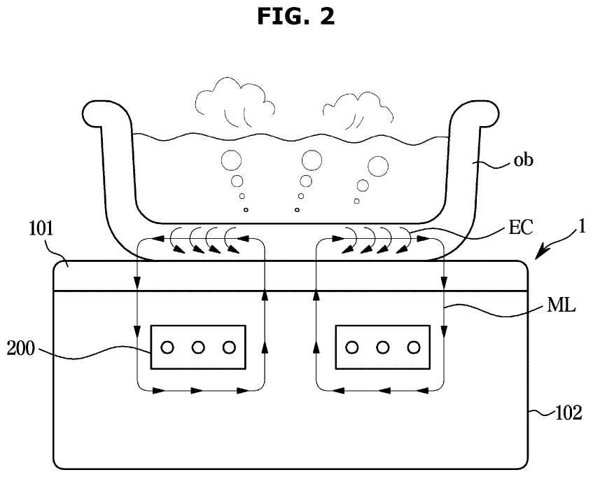

FIG. 2 illustrates a cooking apparatus that heats an object to be cooked according to an embodiment of the disclosure.

The working coil 200 may be arranged below the plate 101 to heat an object ob placed on the plate 101. In FIG. 2, only one working coil 200 is illustrated for convenience of description, but a plurality of working coils 200 may be provided.

The working coil 200 may be connected to a coil driver circuit 10 to be described below, and a high-frequency current may be applied from the coil driver circuit 10. For example, a frequency of the high-frequency current may be 20 kHz to 35 kHz.

As the high-frequency current is supplied to the working coil 200, magnetic force lines ML may be formed in or around the working coil 200. In a case where an object ob having resistance is located within a range where the magnetic force lines ML reach, the magnetic force lines ML around the working coil 200 may pass through a bottom of the object ob, thereby generating an induced current in the form of a vortex according to the electromagnetic induction law, i.e., an eddy current EC.

The eddy current EC may interact with the electric resistance of the object ob, generating heat in or on the object, and food inside the object ob may be heated by the generated heat.

In the cooking apparatus 1, because the object ob itself acts as a heat source, a metal having a predetermined level of resistance or higher, such as iron, stainless steel, or nickel, may be used as a material of the object ob.

From the perspective of the coil driver circuit 10, the object ob acts as a resistor, which is an electrical load. Here, a resistance value of the object ob may be referred to as an equivalent resistance of the object ob.

In the disclosure, the equivalent resistance of the object ob may refer to an equivalent resistance of the coil driver circuit 10.

In the disclosure, the equivalent resistance of the object ob may refer to the equivalent resistance of the load circuit including the coil driver circuit 10 and the object ob.

The equivalent resistance of the object ob corresponds to a critical value in controlling the working coil 200 that heats the object ob.

In order for the cooking apparatus 1 to heat the object ob with optimal efficiency, the equivalent resistance of the object ob requires to be accurately identified.

For example, in a case where the equivalent resistance of the object ob may be accurately identified, the cooking apparatus 1 may determine an optimal power value required to heat the object ob and/or an optimal operating frequency and/or an optimal operating duty ratio of the inverter for heating the object ob.

However, the equivalent resistance of the object ob may be changed by a thickness, surface area, shape, material, etc. of the object ob, may be changed by a shape, size, and number of turns of the working coil 200, and may be changed by a frequency, power, and the like of alternating current (AC) power applied to the coil driver circuit 10.

In existing technologies, an equivalent resistance of an object may not be accurately identified. In existing technologies, a cooking apparatus requires to perform a separate identification process to identify the equivalent resistance of the object.

The separate identification process is separated from a heating process for heating the object, and the existing cooking apparatus may not heat the object while performing the identification process.

The working coil 200 may be designed to have its own inductance.

When the object ob is placed above the working coil 200, the inductance of the working coil 200 changes from the perspective of the coil driver circuit 10. The finally determined inductance of the working coil 200 may be referred to as the equivalent inductance of the object ob.

In the disclosure, the equivalent inductance of the object ob may refer to the equivalent inductance of the coil driver circuit 10.

In the disclosure, the equivalent inductance of the object ob may refer to the equivalent inductance of the load circuit including the coil driver circuit 10 and the object ob.

Meanwhile, in order for the cooking apparatus 1 to heat the object ob with optimal efficiency or to identify whether the object ob is a foreign substance, the equivalent inductance of the object ob requires to be accurately identified.

That is, the equivalent inductance of the object ob is a critical value in controlling the working coil 200 that heats the object ob.

In order for the cooking apparatus 1 to heat the object ob with optimal efficiency, the equivalent inductance of the object ob requires to be accurately identified.

For example, in a case where the equivalent inductance of the object ob may be accurately identified, the cooking apparatus 1 may determine the optimal power value required to heat the object ob and/or the optimal operating frequency and/or the optimal operating duty ratio of the inverter for heating the object ob.

However, the equivalent inductance of the object ob may be changed by a thickness, surface area, shape, material, etc. of the object ob, may be changed by a distance and an alignment relationship between the working coil 200 and the object ob, and the like, and may be changed by a frequency, power, and the like of the AC power applied to the coil driver circuit 10.

In existing technologies, an equivalent inductance of an object may not be accurately identified. In existing technologies, a cooking apparatus requires to perform a separate identification process to identify the equivalent inductance of the object.

The separate identification process is separated from a heating process for heating the object, and the existing cooking apparatus may not heat the object while performing the identification process.

As will be described later, the cooking apparatus 1 according to an embodiment may accurately identify the equivalent resistance and the equivalent inductance of the object ob while heating the object ob.

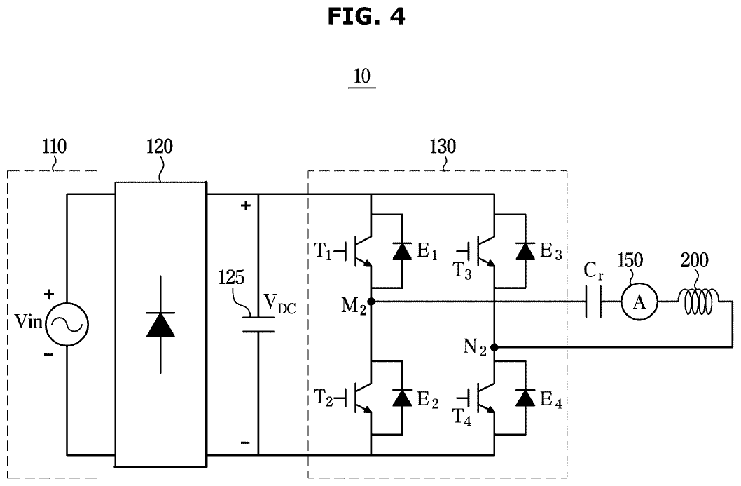

FIG. 3 and FIG. 4 illustrate examples of a coil driver circuit of a cooking apparatus according to an embodiment.

FIG. 3 illustrates a half-bridge inverter circuit as an example of the coil driver circuit 10, and FIG. 4 illustrates a full-bridge inverter circuit as another example of the coil driver circuit 10.

The coil driver circuit 10 according to an embodiment of the disclosure may be implemented as a half-bridge inverter circuit or a full-bridge inverter circuit.

Referring to FIG. 3 and FIG. 4, the coil driver circuit 10 may include an AC power supply Vin, an AC power supply section 110, a rectifier section 120, a DC link capacitor 125, across a DC voltage V_{DC}, an inverter 130, the working coil 200, a current sensor 150, and a resonant capacitor Cr.

The AC power supply section 110 may supply AC power (or AC voltage) supplied from an external power source to the inverter 130.

Supplying the AC power to the inverter 130 may include transmitting the AC power to the rectifier section 120.

The rectifier section 120 may convert the AC power supplied from the AC power supply section 110 into DC power (or DC voltage).

To this end, the rectifier section 120 may include a bridge rectifier circuit including a plurality of diodes. For example, the bridge rectifier circuit may include four diodes. The diodes form diode pairs in which two are connected in series, and the two diode pairs may be connected in parallel with each other. The bridge diode may convert an AC voltage whose polarity changes with time into a voltage whose polarity is constant, and may convert an AC current whose direction changes with time into a current whose direction is constant.

The DC link capacitor 125 may be a component of the rectifier section 120 and may supply DC power to the inverter 130.

In the disclosure, the DC power supplied to the inverter 130 may be referred to as input power supplied to the inverter 130.

According to various embodiments, the coil driver circuit 10 may further include a filter circuit for removing noise mixed into the power supplied from the AC power supply section 110, and a power factor correction (PFC) circuit for improving a power factor of the voltage rectified by the rectifier section 120.

In the case of the half-bridge inverter circuit shown in FIG. 3, the inverter 130 may include a single upper switching element S₁ and a single lower switching element S₂.

An upper freewheeling diode D₁ may be connected in parallel to the upper switching element S₁, and a lower freewheeling diode D₂ may be connected in parallel to the lower switching element S₂.

The upper switching element S₁ and the lower switching element S₂ may be operated to each other in a complementary manner, thereby allowing an alternating current to flow in the working coil 200.

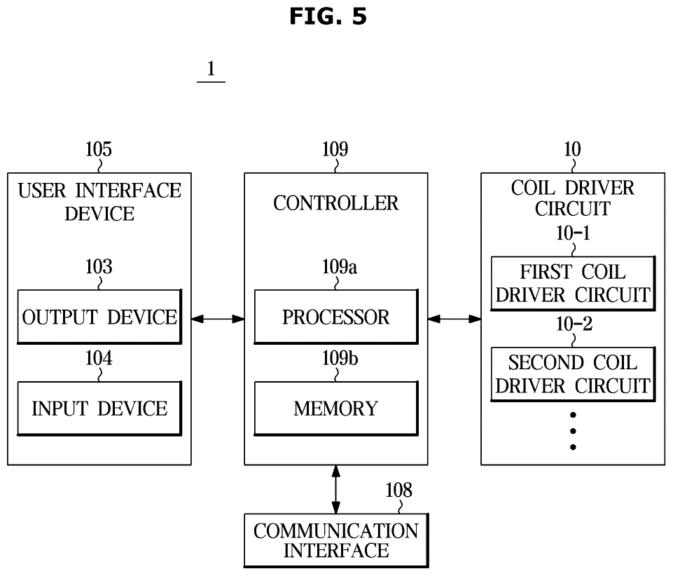

The upper switching element S₁ and the lower switching element S₂ may be turned on/off by a switch driving signal. In this instance, the switch driving signal may be provided by a controller (109, see FIG. 5), and the controller 109 may supply a high-frequency alternating current to the working coil 200 by alternately turning on/off the upper switching element S₁ and the lower switching element S₂.

The upper switching element S₁ and the lower switching element S₂ may be implemented as a three-terminal semiconductor device switch having a fast response speed in order to be turned on/off at high speed. For example, the upper switching element S₁ and the lower switching element S₂ may be provided as a bipolar junction transistor (BJT), a metal-oxide-semiconductor field effect transistor (MOSFET), an insulated gate bipolar transistor (IGBT), or a thyristor.

The resonant capacitor Cᵣ may include an upper resonant capacitor and a lower resonant capacitor.

One end of the upper resonant capacitor may be connected to an upper node of the upper switching element S₁, and the other end of the upper resonant capacitor may be connected to the working coil 200.

One end of the lower resonant capacitor may be connected to the working coil 200, and the other end of the lower resonant capacitor may be connected to a lower node of the lower switching element S₂.

The resonant capacitor Cᵣ may form a resonant circuit together with the working coil 200 to generate a resonance phenomenon at a specific frequency, thereby allowing a resonant current to flow in the working coil 200 according to a switching operation of the upper switching element S₁ and the lower switching element S₂.

The working coil 200 may be installed at a contact point of the upper switching element S₁ and the lower switching element S₂.

According to the switching operation of the upper switching element S₁ and the lower switching element S₂, current may flow in the working coil 200.

The current sensor 150 may be installed on a current path between the contact point of the upper switching element S₁ and the lower switching element S₂ and the working coil 200. The current sensor 150 may detect the current flowing in the working coil 200.

In the disclosure, the current flowing in the working coil 200 may be referred to as a resonant current.

The current sensor 150 may include a current transformer to proportionally reduce a magnitude of the drive current supplied to the working coil 200 and an ampere meter to detect a magnitude of the proportionally reduced current.

Information about the magnitude of the current detected by the current sensor 150 may be provided to the controller 109. As described below, the controller 109 may determine equivalent parameters (e.g., equivalent inductance and equivalent resistance) of the object ob based on information about the detected magnitude of the current.

Detecting the current flowing in the working coil 200 may include detecting the magnitude and/or phase of the current flowing in the working coil 200. In a case where the magnitude of the current flowing in the working coil 200 is detected over time, the controller 109 may identify a phase difference between the input power of the inverter 130 and the resonant current.

In the disclosure, the phase difference between the input power of the inverter 130 and the resonant current may refer to a phase difference between a pole voltage of the inverter 130 and the resonant current.

The pole voltage of the inverter 130 may refer to a potential difference between a pole node M1 corresponding to the contact point of the upper switching element S₁ and the lower switching element S₂ and a reference node N₁ corresponding to the lower node of the lower switching element S₂.

When the upper switching element S₁ is turned on and the lower switching element S₂ is turned off, the pole voltage of the inverter 130 may correspond to +V_{DC}.

When the upper switching element S₁ is turned off and the lower switching element S₂ is turned on, the pole voltage of the inverter 130 may correspond to 0V.

According to various embodiments, the coil driver circuit 10 may include a plurality of inverters 130 connected to the single rectifier section 120.

In a case where the coil driver circuit 10 includes a plurality of inverters, the coil driver circuit 10 may include a current sensor, working coil, and resonant capacitor corresponding to each of the plurality of inverters.

For example, in order to drive the dual working coils 200L and 200H described above, the coil driver circuit 10 may include a first inverter for driving the first dual coil 200L, a first current sensor for detecting a resonant current flowing in the first dual coil 200L, and a first resonant capacitor for forming a resonant circuit with the first dual coil 200L, and may include a second inverter for driving the second dual coil 200H, a second current sensor for detecting a resonant current flowing in the second dual coil 200H, and a second resonant capacitor for forming a resonant circuit with the second dual coil 200H.

In the case of the full bridge inverter circuit shown in FIG. 4, the inverter 130 may include a plurality of upper switching elements T₁ and T₃ and a plurality of lower switching elements T₂ and T₄.

Upper freewheeling diodes E₁ and E₃ may be connected in parallel to the plurality of upper switching elements T₁ and T₃, respectively, and lower freewheeling diodes E₂ and E₄ may be connected in parallel to the plurality of lower switching elements T₂ and T₄, respectively.

The upper switching elements T₁ and T₃ and the lower switching elements T₂ and T₄ may be operated to each other in a complementary manner, thereby allowing an alternating current to flow in the working coil 200.

For example, when the first upper switching element T₁ is turned on, the first lower switching element T₂ connected to the first upper switching element T₁ may be turned off. When the first upper switching element T₁ is turned off, the first lower switching element T₂ may be turned on. When the second upper switching element T₃ is turned on, the second lower switching element T₄ connected to the second upper switching element T₃ may be turned off. When the second upper switching element T₃ is turned off, the second lower switching element T₄ may be turned on.

The upper switching elements T₁ and T₃ and the lower switching elements T₂ and T₄ may be turned on/off by a switch driving signal. In this instance, the switch driving signal may be provided by the controller (109, see FIG. 5), and the controller 109 may supply a high-frequency alternating current to the working coil 200 by alternately turning on/off the upper switching elements T₁ and T₃ and the lower switching elements T₂ and T₄.

The working coil 200 may be provided between a pole node M₂ corresponding to a contact point between the first upper switching element T₁ and the first lower switching element T₂, and a reference node N₂ corresponding to a contact point between the second upper switching element T₃ and the second lower switching element T₄.

A resonant capacitor Cᵣ may be installed between the pole node M₂ and the reference node N₂. Accordingly, the resonant capacitor Cᵣ and the working coil 200 may be connected in series.

The current sensor 150 may be installed between the pole node M₂ and the reference node N₂. The current sensor 150 may detect the current flowing in the working coil 200.

In the disclosure, a phase difference between an input power of the inverter 130 and a resonant current may refer to a phase difference between a pole voltage of the inverter 130 and the resonant current.

The pole voltage of the inverter 130 may refer to a potential difference between the pole node M₂ and the reference node N₂.

In a case where the first upper switching element T₁ is turned on, the first lower switching element T₂ is turned off, the second upper switching element T₃ is turned off, and the second lower switching element T₄ is turned on, the pole voltage of the inverter 130 may correspond to +V_{DC}.

In a case where the first upper switching element T₁ is turned on, the first lower switching element T₂ is turned off, the second upper switching element T₃ is turned on, and the second lower switching element T₄ is turned off, the pole voltage of the inverter 130 may correspond to 0V.

In a case where the first upper switching element T₁ is turned off, the first lower switching element T₂ is turned on, the second upper switching element T₃ is turned on, and the second lower switching element T₄ is turned off, the pole voltage of the inverter 130 may correspond to −VD_{C.}

In a case where the first upper switching element T₁ is turned off, the first lower switching element T₂ is turned on, the second upper switching element T₃ is turned off and the second lower switching element T₄ is turned on, the pole voltage of the inverter 130 may correspond to 0V.

As described above, according to various embodiments, the coil driver circuit 10 may include a plurality of inverters 130 connected to the single rectifier section 120.

In a case where the coil driver circuit 10 includes a plurality of inverters, the coil driver circuit 10 may include a current sensor, working coil, and resonant capacitor corresponding to each of the plurality of inverters.

FIG. 5 is a block diagram illustrating an example configuration of a cooking apparatus according to an embodiment.

Referring to FIG. 5, the cooking apparatus 1 according to an embodiment may include a user interface device 105, the controller 109, the coil driver circuit 10, and/or a communication interface 108.

The user interface device 105 may enable interaction between a user and the cooking apparatus 1.

The user interface device 105 may include the output device 103 and the input device 104.

The at least one output device 103 may generate sensory information and transmit various information related to the operation of the cooking apparatus 1 to the user.

For example, the at least one output device 103 may transmit information related to the settings and an operation time of the cooking apparatus 1 to the user. Information related to the operation of the cooking apparatus 1 may be output by a display, an indicator, and/or a voice. The at least one output device 103 may include, for example, a liquid crystal display (LCD) panel, an indicator, a light emitting diode (LED) panel, a speaker, and the like.

In an embodiment, the at least one output device 103 may output sensory information (e.g., visual information, auditory information, etc.) related to the control of the cooking apparatus 1.

The at least one input device 104 may convert sensory information received from the user into an electrical signal.

In a case where the user interface device 105 includes a touch screen display, the touch screen display may correspond to an example of the output device 103 and the input device 104.

The at least one input device 104 may include an input device (e.g., a button) for turning on the cooking apparatus 1.

The at least one input device 104 may include an input device (e.g., a button, a knob, etc.) for controlling a thermal power of the working coil 200 of the cooking apparatus 1.

Each button may include a visual indicator (e.g., a phrase, an icon, etc.) that may indicate its function.

The at least one input device 104 may include, for example, a tact switch, a push switch, a slide switch, a toggle switch, a micro switch, a touch switch, a touch pad, a touch screen, a jog dial, and/or a microphone.

In the disclosure, a ‘button’ may be replaced with a UI element (User Interface Element), a tact switch, a push switch, a slide switch, a toggle switch, a micro switch, a touch switch, a touch pad, a touch screen, a jog dial, and/or a microphone.

The cooking apparatus 1 may process user input received through the user interface device 105 and may output information related to the cooking apparatus 1 through the user interface device 105.

The cooking apparatus 1 may control an operation of the cooking apparatus 1 based on the user input received through the user interface device 105.

The communication interface 108 may communicate with an external device (e.g., a server, a user device) wirelessly or by wire.

The communication interface 108 may include at least one of a short-range wireless communication module or a long-range wireless communication module.

The communication interface 108 may transmit data to an external device (e.g., a server, a user device) or may receive data from the external device. For the communication, the communication interface 108 may establish a direct (e.g., wired) communication channel or a wireless communication channel between external devices, and support the performance of the communication through the established communication channel. According to an embodiment, the communication interface 108 may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with the external device through a first network (e.g., a short-range wireless communication network such as Bluetooth, wireless fidelity (Wi-Fi) direct, or infrared data association (IrDA) or a second network (e.g., a long-range wireless communication network such as a legacy cellular network, a 5G network, a next-generation communication network, the Internet, or a computer network (e.g., LAN or WAN)). These various types of communication modules may be integrated as one component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication interface. The mobile communication interface transmits and receives radio signals with at least one of a base station, an external terminal, or a server on a mobile communication network.

In an embodiment, the communication interface 108 may communicate with an external device through a nearby access point (AP). The access point may connect a local area network (LAN), to which the cooking apparatus 1 is connected, to a wide area network (WAN) to which the server is connected. The cooking apparatus 1 may be connected to the server through the wide area network (WAN).

The cooking apparatus 1 may receive various signals from an external device through the communication interface 108.

The cooking apparatus 1 may transmit various signals to the external device through the communication interface 108.

The coil driver circuit 10 may include a plurality of coil driver circuits.

For example, the coil driver circuit 10 may include a first coil driver circuit 10-1 and a second coil driver circuit 10-2.

Each of the plurality of coil driver circuits 10 may be configured to control at least one working coil 200. Controlling the at least one working coil 200 may include controlling the inverter 130 connected to at least one working coil 200.

In an embodiment, the first coil driver circuit 10-1 may be configured to control the second working coil 200a of FIG. 1A, and the second coil driver circuit 10-2 may be configured to control the third working coil 200b of FIG. 1A.

In an embodiment, the first coil driver circuit 10-1 or the second coil driver circuit 10-2 may be configured to control the first dual coil 200L and the second dual coil 200H of FIG. 1A.

In an embodiment, each of the first coil driver circuit 10-1 and the second coil driver circuit 10-2 may be configured to control each of the plurality of working coils 200 of FIG. 2.

The coil driver circuit 10 may include the current sensor 150 that measures the resonant current flowing in the working coil 200.

The current sensor 150 may transmit information about the resonant current flowing in the working coil 200 to the controller 109.

The coil driver circuit 10 may operate based on a control signal of the controller 109. For example, the controller 109 may control the inverter 130 of the coil driver circuit 10.

Controlling the inverter 130 may include controlling the switching elements S₁, S₂, T₁, T₂, T₃, and T₄.

Controlling the inverter 130 may include controlling an operating frequency and/or an operating duty ratio of the inverter 130.

In the disclosure, the operating frequency of the inverter 130 may refer to switching frequencies of the switching elements S₁, S₂, T₁, T₂, T₃, and T₄.

In the disclosure, the operating frequency of the inverter 130 may correspond to a frequency of an AC power.

In the disclosure, controlling the operating frequency of the inverter 130 may include controlling the frequency of the AC power supplied by the AC power supply section 110.

In the disclosure, the operating duty ratio of the inverter 130 may refer to a ratio between a period in which the pole voltage of the inverter 130 is a positive value and a period in which the pole voltage of the inverter 130 is 0V within a single switching cycle corresponding to the operating frequency of the inverter 130.

In the disclosure, the operating duty ratio of the inverter 130 may also be referred to as a duty cycle of the inverter 130, and may refer to a ratio of an on/off time of the power.

Although not shown in FIG. 5, the cooking apparatus 1 according to an embodiment may include various sensors in addition to the current sensor 150 included in the coil driver circuit 10.

For example, the cooking apparatus 1 may include a capacitance sensor for detecting a change in capacitance that changes when a cooking container is placed on the plate 101.

The controller 109 may identify that an object ob is placed on the plate 101 based on a change value of electrostatic capacitance detected by the capacitance sensor. Further, the controller 109 may identify a position where the object ob is placed on the plate 101 based on the change value of the electrostatic capacitance detected by the capacitance sensor. That is, the controller 109 may identify which working coil among the plurality of working coils 200 is capable of heating the object ob.

The controller 109 may process a user input received from the input device 104.

The controller 109 may process data collected from the coil driver circuit 10 and/or other various sensors.

The controller 109 may control various components of the cooking apparatus 1 (e.g., the user interface device 105, the communication interface 108, and the coil driver circuit 10).

The controller 109 may include at least one processor 109a that controls the operation of the cooking apparatus 1, and at least one memory 109b that stores a program and data for controlling the operation of the cooking apparatus 1.

The at least one memory 109b may store data required for various embodiments. The memory 109b may be implemented as a memory embedded in the cooking apparatus 1 or as a memory removable from the cooking apparatus 1, depending on the data storage purpose. For example, data for driving the cooking apparatus 1 may be stored in the memory embedded in the cooking apparatus 1, and data for extended functions of the cooking apparatus 1 may be stored in the memory removable from the cooking apparatus 1. Meanwhile, the memory embedded in the cooking apparatus 1 may be implemented as at least one of volatile memory (e.g., dynamic random access memory (DRAM), static random access memory (SRAM), or synchronous dynamic random access memory (SDRAM), etc.), or non-volatile memory (e.g., one time programmable read-only memory (OTPROM), programmable read-only memory (PROM), erasable and programmable read-only memory (EPROM), electrically erasable and programmable read-only memory (EEPROM), mask read-only memory (mask ROM), flash ROM, flash memory (e.g. NAND flash or NOR flash, etc.), hard drive, or solid state drive (SSD)). The memory removable from the cooking apparatus 1 may be implemented as a memory card (e.g., compact flash (CF), secure digital (SD), micro secure digital (Micro-SD), mini secure digital (Mini-SD), extreme digital (xD), multi-media card (MMC), etc.), an external memory (e.g., universal serial bus (USB) memory) that is connectable to a USB port, and the like.

The at least one processor 109a may control overall operation of the cooking apparatus 1. Specifically, the at least one processor 109a may be connected to each component of the cooking apparatus 1 and control the overall operation of the cooking apparatus 1. For example, the at least one processor 109a may be electrically connected to the memory 109b to control the overall operation of the cooking apparatus 1. A single processor or a plurality of processors may be provided as the processor 109a.

The at least one memory 109b may store an algorithm for controlling the user interface device 105 and processing user input entered through the user interface device 105.

For example, the at least one memory 109b may store an algorithm for providing various interfaces through the user interface device 105.

In an embodiment, the at least one memory 109b may store an algorithm for determining (predicting, estimating, or identifying) an equivalent inductance and an equivalent resistance of the object ob based on a magnitude and phase of the resonant current measured by the current sensor 150.

The at least one processor 109a may perform operation of the cooking apparatus 1 according to various embodiments by executing at least one instruction stored in the memory 109b.

The at least one processor 109a may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 109a may control one or any combination of the other components of the cooking apparatus 1, and may perform communication-related operations or data processing. The at least one processor 109a may execute at least one program or instruction stored in the memory 109b. For example, the at least one processor 109a may perform a method according to at least one embodiment of the disclosure by executing at least one instruction stored in the memory 109b.

The controller 109 may start a heating operation for heating the object ob placed on the plate 101 based on a user input entered through the input device 104.

Performing a heating operation for heating the object ob placed on the plate 101 may include controlling the coil driver circuit 10, including a working coil corresponding to a cooking area selected by a user via the input device 104, based on an input parameter corresponding to a heat level set by the user via the input device 104.

Here, the input parameter corresponding to the heat level set by the user may include an input power or an input voltage, and an operating frequency and/or an operating duty ratio of the inverter 130.

The input voltage and the operating frequency and/or the operating duty ratio of the inverter 130 may be determined by the input power.

The input voltage may refer to a magnitude of a DC voltage supplied to the inverter 130.

Meanwhile, the input parameter corresponding to the heat level may be changed based on an equivalent parameter (e.g., equivalent inductance and equivalent resistance) of the object ob.

That is, the controller 109 may control the input voltage, the operating frequency of the inverter, and the operating duty ratio of the inverter based on the heat level set by the user and the equivalent parameter of the object ob.

As will be described below, the controller 109 may determine the equivalent parameter of the object ob in real time during a heating operation.

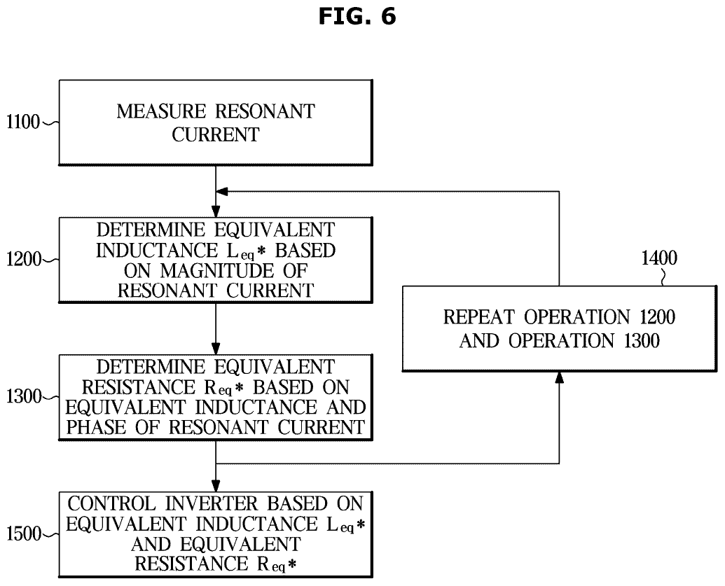

FIG. 6 is a flowchart illustrating an example of a method for controlling a cooking apparatus according to an embodiment.

Referring to FIG. 6, the cooking apparatus 1 according to an embodiment may start a heating operation according to a user input.

For example, the controller 109 may control the coil driver circuit 10 including the working coil 200, corresponding to a cooking area selected by a user via the input device 104, based on an input parameter corresponding to a heat level set by the user via the input device 104. Controlling the coil driver circuit 10 may include controlling the inverter 130.

Controlling the inverter 130 may include controlling an input voltage and an operating frequency and/or an operating duty ratio of the inverter 130 based on an input parameter preset by a user input.

As the switching elements S₁, S₂, T₁, T₂, T₃, and T₄ included in the inverter 130 operate, a resonant current may flow in the working coil 200.

The current sensor 150 may measure the resonant current (1100).

The current sensor 150 may transmit information about a magnitude of the resonant current to the controller 109.

The controller 109 may determine an equivalent parameter of an object ob based on the resonant current measured by the current sensor 150. Determining the equivalent parameter of the object ob based on the resonant current measured by the current sensor 150 may include determining the equivalent parameter of the object ob using only the resonant current measured by the current sensor 150 as a single variable, without other variables.

According to one of the existing technologies, an equivalent parameter is estimated by inverse calculation based on an input power supplied to an inverter. In this case, because the equivalent parameter is calculated inversely based on the input power, an output power actually consumed by a working coil may not be easily calculated.

According to one of the existing technologies, in order to determine the equivalent parameter of the object, a cooking apparatus performs a separate identification process before a heating process. In the identification process, the cooking apparatus operates an inverter based on a predetermined pulse signal, and a damped oscillation time and a damped oscillation period of a resonant circuit including a working coil and a resonant capacitor are measured to determine the equivalent parameter of the object. However, in the existing technologies, the cooking apparatus may not continuously determine the equivalent parameter of the object after the identification process, and the heating process is to be performed after the identification process, resulting in a delay in a start of the heating process. Further, in the existing technologies, in a case where a position of the object is changed during cooking, the equivalent parameter of the object is not considered to be changed.

According to an embodiment of the disclosure, the controller 109 may determine the equivalent parameter of the object ob in real time based on the resonant current measured by the current sensor 150 during the heating process.

The controller 109 may determine an equivalent inductance L_{eq*} based on the magnitude of the resonant current measured by the current sensor 150 (1200).

In the disclosure, the symbol L_{eq*} may refer to the equivalent inductance value determined by the controller 109.

The controller 109 may determine an equivalent resistance R_{eq*} based on the equivalent inductance L_{eq*} and a phase of the resonant current measured by the current sensor 150 (1300).

In the disclosure, the symbol R_{eq*} may refer to the equivalent resistance value determined by the controller 109.

The controller 109 according to an embodiment may repeatedly perform operations 1200 and 1300 (1400).

For example, the controller 109 may repeatedly perform operations 1200 and 1300 from the start of the heating process to the end of the heating process.

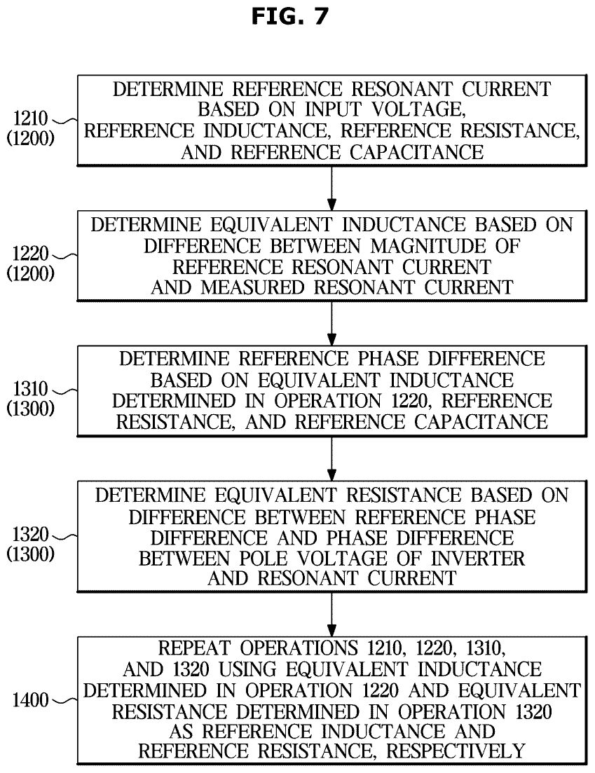

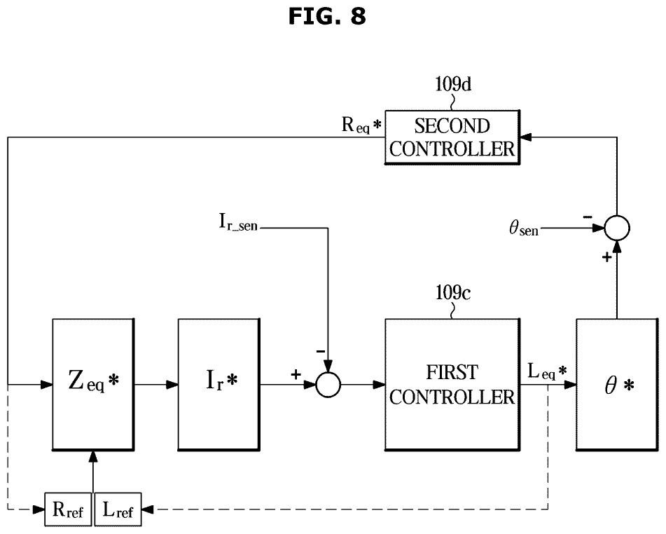

A method of determining an equivalent parameter of the object ob by repeatedly performing operations 1200 and 1300 by the controller 109 is described in detail below with reference to FIG. 7 to FIG. 8.

The controller 109 may control the inverter 130 based on at least one of the equivalent inductance L_{eq*} determined in operation 1200 or the equivalent resistance R_{eq*} determined in operation 1300 (1500).

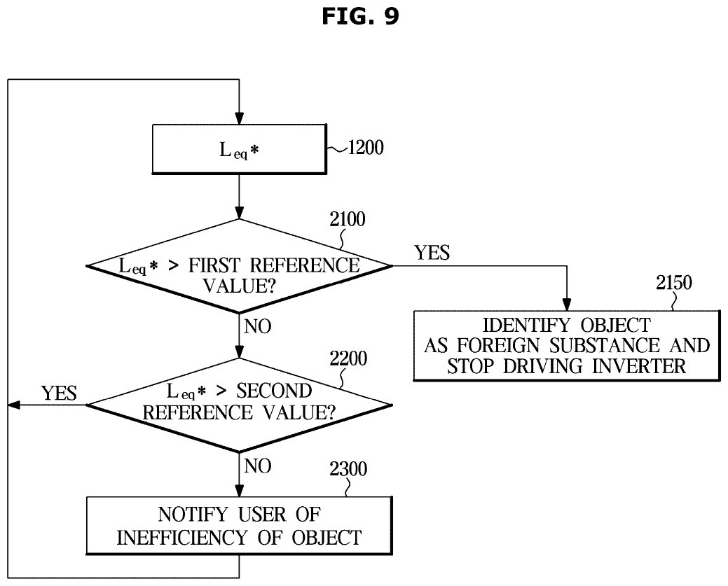

A method for controlling the inverter 130 based on at least one of the equivalent inductance L_{eq*} or the equivalent resistance Re_{q*} is described in detail below with reference to FIG. 9 to FIG. 12.

In an embodiment, the controller 109 may reduce power consumption and efficiently heat the object ob by controlling the operating frequency and/or the operating duty ratio of the inverter 130 based on at least one of the equivalent inductance L_{eq*} or the equivalent resistance R_{eq*}.

To this end, the memory 109b may store a lookup table in which an optimal operating frequency and/or an optimal operating duty ratio corresponding to the equivalent inductance L_{eq*} and the equivalent resistance R_{eq*} are matched, or may store instructions for determining the optimal operating frequency and/or the optimal operating duty ratio based on the equivalent inductance L_{eq*} and the equivalent resistance R_{eq*}.

According to the disclosure, the cooking apparatus 1 may heat the object ob with optimal efficiency by identifying an accurate equivalent parameter of the object ob in real time.

FIG. 7 is a flowchart illustrating an example of an equivalent inductance estimation operation and an equivalent resistance estimation operation, in a method for controlling a cooking apparatus according to an embodiment. FIG. 8 is a conceptual block diagram for performing an equivalent inductance estimation operation and an equivalent resistance estimation operation by a cooking apparatus according to an embodiment.

Referring to FIG. 7 and FIG. 8, the controller 109 may determine a reference resonant current based on an input voltage supplied to the inverter 130, a reference inductance, a reference resistance, and a reference capacitance (1210).

Here, the reference inductance, the reference resistance, and the reference capacitance may be preset in advance and stored in the memory 109b.

For example, the reference inductance stored in the memory 109b may be preset when manufacturing the cooking apparatus 1 to correspond to a unique inductance of the working coil 200, the reference resistance stored in the memory 109b may be preset when manufacturing the cooking apparatus 1 to correspond to a reference resistance of a commonly used cooking container, and the reference capacitance stored in the memory 109b may be preset when manufacturing the cooking apparatus 1 to correspond to a capacitance of a resonant capacitor Cᵣ.

In an embodiment, only when operation 1210 and/or operation 1310 is performed for the first time after the heating process is started, the controller 109 may use the reference inductance stored in the memory 109b and the reference resistance stored in the memory 109b as the reference inductance and the reference resistance.

The input voltage may refer to an RMS value of the voltage applied to the inverter 130.

For the half-bridge inverter circuit shown in FIG. 3, the input voltage V_{r1,rms} may be calculated by [Equation 1] below.

$${V}_{r 1 , rms} = \frac{\sqrt{2}}{π} {V}_{i n , r m s} \qquad [ Equation 1 ]$$

For the full bridge inverter circuit shown in FIG. 4, the input voltage V_{r1,rms} may be calculated by [Equation 2] below.

$${v}_{r 1 , rms} = \frac{2 \sqrt{2}}{π} {V}_{i n , r m s} \qquad [ Equation 2 ]$$

In [Equation 1] or [Equation 2], V_{in,rms} is the RMS value of AC power, which corresponds to a variable already ascertained by the controller 109. That is, the controller 109 may ascertain the input voltage applied to the inverter 130.

An equivalent impedance Z_{eq} of the coil driver circuit 10 may be calculated by [Equation 3] below.

$${Z}_{e q} = \sqrt{{( {R}_{e q} )}^{2} + {( ω {L}_{e q} - \frac{1}{ω {C}_{r}} )}^{2}} \qquad [ Equation 3 ]$$

Here, R_{eq} may be an equivalent resistance of the object ob, L_{eq} may be an equivalent inductance of the object ob, Cᵣ may be the capacitance of the resonant capacitor included in the coil driver circuit 10, and ω may be an angular velocity 2πf corresponding to the operating frequency f of the inverter 130.

The capacitance of the resonant capacitor may be pre-stored in the memory 109b as a reference capacitance. The operating frequency f of the inverter 130 is a variable controlled by the controller 109.

That is, from the perspective of the controller 109, the unknowns are the equivalent resistance R_{eq} of the object ob and the equivalent inductance L_{eq} of the object ob.

The resonant current Iᵣ flowing in the working coil 200 may be calculated by [Equation 4] below.

$${I}_{r} = \frac{{V}_{r 1 , rms}}{\sqrt{{( {R}_{e q} )}^{2} + {( ω {L}_{e q} - \frac{1}{ω {C}_{r}} )}^{2}}} \qquad [ Equation 4 ]$$

The controller 109 may not ascertain the R_{eq} and L_{eq} of the coil driver circuit 10.

Accordingly, in operation 1210 performed for the first time after the heating operation starts, the controller 109 may use a reference resistance R_{ref} pre-stored in the memory 109b as the equivalent resistance R_{eq} of the coil driver circuit 10 and use a reference inductance L_{ref} pre-stored in the memory 109b as the equivalent inductance L_{eq} of the coil driver circuit 10 to determine a reference impedance Z_{e*}, and thus determine a reference resonant current I_{r*}.

Here, the reference impedance Z_{eq*} may be determined by [Equation 5] below.

$${Z}_{e q} *= \sqrt{{( {R}_{r e f} )}^{2} + {( ω {L}_{r e f} - \frac{1}{ω {C}_{r}} )}^{2}} \qquad [ Equation 5 ]$$

As a result, the reference resonant current I_{r*} may be determined by [Equation 6] below.

$${I}_{r} *= \frac{{V}_{r 1 , rms}}{\sqrt{{( {R}_{r e f} )}^{2} + {( ω {L}_{r e f} - \frac{1}{ω {C}_{r}} )}^{2}}} \qquad [ Equation 6 ]$$

That is, the controller 109 may determine the reference resonant current I_{r*} by replacing R_{eq} and L_{eq} of the coil driver circuit 10 with arbitrary reference values R_{ref} and L_{ref}. Determining the reference resonant current I_{r*} may include determining a magnitude of the reference resonant current I_{r*}.

The controller 109 may determine an equivalent inductance L_{eq*} based on a difference between the magnitude of the reference resonant current I_{r*} and a magnitude of the resonant current Ir_sen measured by the current sensor 150 (1220).

For convenience of description, the difference between the magnitude of the reference resonant current I_{r*} and the magnitude of the resonant current Ir_sen measured by the current sensor 150 is defined as a current error value.

The controller 109 may include a first controller 109c that determines the equivalent inductance L_{eq*} based on the current error value.

The first controller 109c may include a proportional-integral (PI) controller or a proportional-integral-derivative (PID) controller.

The PI controller or the PID controller may adjust an output value to minimize an input current error value. Here, the output value may correspond to the equivalent inductance L_{eq*}.

That is, the first controller 109c may be configured to output the equivalent inductance L_{eq*} that causes the current error value to converge to 0.

The controller 109 may determine a reference phase difference θ* based on the equivalent inductance L_{eq*} determined in operation 1220, the reference resistance R_{ref}, and the reference capacitance C, (1310).

Here, the reference phase difference θ* refers to a phase difference θ between a pole voltage of the inverter 130 and resonant current.

The phase difference θ between the pole voltage of the inverter 130 and the resonant current may be calculated by [Equation 7] below.

$$θ = arctan ( \frac{ω {L}_{e q} - \frac{1}{ω {C}_{r}}}{{R}_{e q}} ) \qquad [ Equation 7 ]$$

The controller 109 may not yet ascertain the R_{eq} and L_{eq} of the coil driver circuit 10.

However, the controller 109 determined the equivalent inductance L_{eq*} of the coil driver circuit 10 in operation 1220.

Accordingly, in the operation 1310 performed for the first time after the heating operation starts, the controller 109 may use the reference resistance R_{ref} pre-stored in the memory 109b as the equivalent resistance R_{eq} of the coil driver circuit 10 and use the equivalent inductance L_{eq*} determined in operation 1220 as the equivalent inductance L_{eq} of the coil driver circuit 10 to determine the reference phase difference θ*

As a result, the reference phase difference θ* may be determined by [Equation 8] below.

$$θ *= arctan ( \frac{ω {L}_{e q} * - \frac{1}{ω {C}_{r}}}{{R}_{r e f}} ) \qquad [ Equation 8 ]$$

That is, the controller 109 may determine the reference phase difference θ* by replacing R_{eq} of the coil driver circuit 10 with arbitrary reference values R_{ref} and L_{ref} and replacing L_{eq} of the coil driver circuit 10 with the equivalent inductance L_{eq*} determined in operation 1220.

The controller 109 may compare a phase of the resonant current measured by the current sensor 150 with a phase of the input power, thereby determining a phase difference Osen between the pole voltage of the inverter 130 and the resonant current.

That is, the phase difference θₛₑₙ between the pole voltage of the inverter 130 and the resonant current may also be measured based on the phase of the resonant current measured by the current sensor 150.

The controller 109 may determine a equivalent resistance R_{eq*} based on a difference between the reference phase difference θ* and the phase difference θₛₑₙ between the pole voltage of the inverter 130 and the resonant current measured by the current sensor 150 (1320).

For convenience of description, the phase difference θₛₑₙ between the pole voltage of the inverter 130 and the resonant current measured by the current sensor 150 is defined as a measured phase difference θₛₑₙ.

For convenience of description, the difference between the reference phase difference θ* and the measured phase difference θₛₑₙ is defined as a phase error value.

The controller 109 may include a second controller 109d that determines the equivalent resistance R_{eq*} based on the phase error value.

The second controller 109d may include a PI controller or a PID controller.

The PI controller or the PID controller may adjust an output value to minimize an input phase error value. Here, the output value may correspond to the equivalent resistance R_{eq*}.

That is, the second controller 109d may be configured to output the equivalent resistance R_{eq*} that causes the phase error value to converge to 0.

Meanwhile, due to the characteristics of the PI controller or PID controller, a predetermined amount of time is required to output the output value to minimize an error value.

A proportional coefficient, integral coefficient, and/or differential coefficient of the first controller 109c and the second controller 109d may be designed in advance to allow a steady-state error and a settling time to be minimized.

The controller 109 may repeat operations 1210, 1220, 1310, and 1320 using the equivalent inductance L_{eq*} determined in operation 1220 and the equivalent resistance R_{eq*} determined in operation 1320 as the reference inductance L_{ref} and the reference resistance R_{ref}, respectively (1400).

In a case where operations 1210 and/or 1310 are not the operations performed for the first time after the heating process starts, the controller 109 may perform operations 1210, 1220, 1310, and 1320 using the equivalent inductance L_{eq*} determined immediately before as the reference inductance L_{ref} and the equivalent resistance R_{eq*} determined immediately before as the reference resistance R_{ref}.

The controller 109 may continuously obtain more accurate equivalent inductance L_{eq*} and equivalent resistance R_{eq*} in real time by closed-loop control for determining the equivalent inductance L_{eq*} and the equivalent resistance R_{eq*}.

According to the simulation results of performing closed-loop control under the condition that an input voltage is set to 240V, an operating frequency of the inverter 130 is set to 24 kHz, a resonant capacitance is 400 nF, an actual equivalent inductance L_{eq} of the object ob is 130 uH, an equivalent resistance R_{eq} of the object ob is 6 Ω, a pre-stored reference inductance L_{ref} is 150 uH, and a pre-stored reference resistance R_{ref pk is} 10 Ω, the equivalent inductance L_{eq*} determined by the closed-loop control converged to 130.3 uH approximately 0.1 second after the start of performing the closed-loop control, and the equivalent resistance R_{eq*} determined by the closed-loop control converged to 6.07 Ω.

According to the disclosure, the controller 109 may accurately measure the equivalent inductance L_{eq*} and the equivalent resistance R_{eq*} of the object ob in real time using only the current sensor 150 that measures the magnitude and/or phase of the resonant current.

According to the disclosure, even in a case where a position of the object ob is changed during the heating process and the equivalent inductance and the equivalent resistance are changed, the changed equivalent inductance and equivalent resistance may be estimated.

According to the disclosure, the controller 109 may efficiently control the inverter 130 based on the equivalent inductance L_{eq*} and the equivalent resistance R_{eq*} measured in real time.

According to various embodiments, the controller 109 may change the reference inductance pre-stored in the memory 109b and the reference resistance pre-stored in the memory 109b based on a use history of the cooking apparatus 1.

In general, when a user uses the cooking apparatus 1, the user uses a cooking container that he or she has, and the equivalent inductance L_{eq} and the equivalent resistance R_{eq} of the same cooking container may be changed within a predetermined range.

In an embodiment, the controller 109 may update the reference inductance L_{ref} pre-stored in the memory 109b and the reference resistance R_{ref} pre-stored in the memory 109b based on the equivalent inductance L_{eq*} and the equivalent resistance R_{eq*} of the object ob determined in each of the plurality of heating processes.

For example, the controller 109 may store an average value of the equivalent inductance L_{eq*} of the object ob determined in each of the plurality of heating processes as the pre-stored reference inductance in the memory 109b, and may store an average value of the equivalent resistance R_{eq*} of the object ob determined in each of the plurality of heating processes as the pre-stored reference resistance in the memory 109b.

According to the disclosure, by continuously updating the pre-stored reference inductance L_{ref} and the pre-stored reference resistance R_{ref} according to the user's history of using the cooking apparatus 1, the equivalent inductance L_{eq*} and the equivalent resistance R_{eq*} may be determined more rapidly in the subsequent heating operation.

FIG. 9 is a flowchart illustrating a method of determining whether an object is a foreign substance, in a method for controlling a cooking apparatus according to an embodiment.

Referring to FIG. 9, the controller 109 may determine the equivalent inductance L_{eq*} in operation 1200.

As described above, operation 1200 may be continuously performed based on the closed loop control illustrated in FIG. 8.

The controller 109 may identify whether an object is a foreign substance based on the equivalent inductance L_{eq*}.

For example, the controller 109 may determine whether the equivalent inductance L_{eq*} is greater than or equal to a first reference value (2100).

The first reference value is a value variable depending on an operating frequency of the inverter 130, and may be preset as a value for determining whether the object ob corresponds to a foreign substance. For example, the first reference value may decrease non-linearly as the operating frequency of the inverter 130 increases.

In the disclosure, the foreign substance is an object ob rather than a cooking container, and may correspond to a dangerous substance when heated.

Because a foreign substance (e.g., scissors, knife, foil, etc.) has a low coupling with the working coil 200, a mutual inductance value with the working coil 200 is low, and thus an equivalent inductance is a relatively high.

The controller 109 may identify that the object ob is a foreign substance based on the equivalent inductance L_{eq*} being greater than or equal to the first reference value, and may stop driving the inverter 130 based on the object ob being identified as a foreign substance (2150).

The controller 109 may output sensory information to notify that the object ob is a foreign substance via the output device 103 based on the object ob being identified as a foreign substance, or may transmit an electrical signal to notify that the object ob is a foreign substance to an external device via the communication interface 108.

Meanwhile, in a case where the equivalent inductance is significantly low, magnetic force lines ML around the working coil 200 are not generated smoothly, and thus a magnitude of an eddy current EC may be small. Accordingly, in a case where the equivalent inductance is significantly low, heat is not generated smoothly in the object ob. In a case where heat is not generated smoothly in the object ob under the same conditions, the object ob may be considered as an inefficient container.

The controller 109 may determine whether the equivalent inductance L_{eq*} is greater than or equal to a second reference value (2200).

The second reference value is a value variable depending on an operating frequency of the inverter 130, and may be preset as a value for determining an efficiency of the object ob.

In a case where the equivalent inductance L_{eq*} is greater than or equal to the second reference value, the controller 109 may control the inverter 130 to be driven at an operating frequency that has an optimal efficiency at the corresponding equivalent inductance L_{eq*}.

Even in a case where the equivalent inductance L_{eq*} is less than the second reference value, the controller 109 may control the inverter 130 to be driven at an operating frequency that has an optimal efficiency at the corresponding equivalent inductance L_{eq*}. However, in a case where the equivalent inductance L_{eq*} is less than the second reference value, the efficiency of the object ob decreases, and thus the object ob requires to be replaced.

The controller 109 may notify the user of an inefficiency of the object ob, in a case where the equivalent inductance L_{eq*} is less than the second reference value (2300).

For example, based on the equivalent inductance L_{eq*} being less than the second reference value, sensory information for notifying the inefficiency of the object ob may be output through the output device 103, or an electrical signal for notifying the inefficiency of the object ob may be transmitted to an external device through the communication interface 108.

Notifying the inefficiency of the object ob may include notifying that the object ob is an inefficient container.

Meanwhile, due to the characteristics of closed-loop control, an accurate equivalent inductance L_{eq*} may be determined when operation 1200 is repeatedly performed for a predetermined period of time.

In an embodiment, the controller 109 may perform the operations illustrated in FIG. 9 only when a predetermined time (e.g., 0.1 second) has elapsed after the heating process has started.

According to the disclosure, whether the object ob is a foreign substance may be accurately identified by accurately estimating the equivalent inductance L_{eq*} of the object ob.

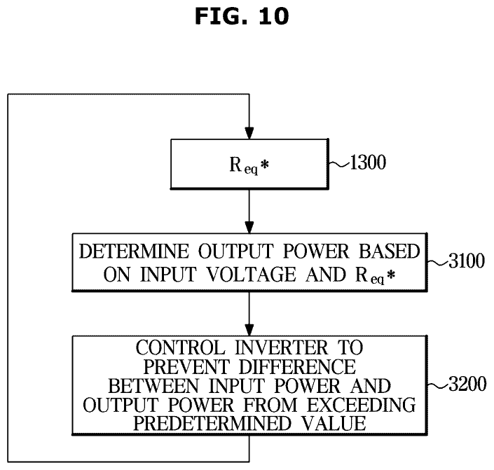

FIG. 10 is a flowchart illustrating a method for controlling an inverter to minimize a loss value, in a method for controlling a cooking apparatus according to an embodiment.

In existing technologies, an equivalent parameter is determined based on a value of an input power supplied to an inverter. In this case, in a case where a coil driver circuit does not include a separate shunt resistor, an output power value consumed by a working coil may not be accurately calculated.

According to an embodiment of the disclosure, because the equivalent resistance R_{eq*} of the object ob is determined based on the measured value of the resonant current flowing in the working coil 200, i.e., because the equivalent resistance R_{eq*} of the object ob is determined regardless of the value of the input power supplied to the inverter 130, the output power value consumed by the working coil 200 may be accurately calculated.

Referring to FIG. 10, the controller 109 may determine the equivalent resistance R_{eq*} in operation 1300.

As described above, operation 1300 may be performed continuously based on the closed loop control illustrated in FIG. 8.

The controller 109 may determine an output power consumed by the working coil 200 based on the equivalent resistance R_{eq*} (3100).

For example, the controller 109 may determine the output power Pₒᵤₜ based on the input voltage V_{DC} supplied to the inverter 130 and the equivalent resistance R_{eq*} using [Equation 9] below.

$${P}_{o u t} = \frac{{V}_{D C}^{2}}{{R}_{e q} *} \qquad [ Equation 9 ]$$

Because the controller 109 ascertains the RMS value of the AC power, i.e., the value of the input power supplied to the inverter 130, the controller 109 may determine a difference between the input power and the output power.

The difference between the input power and the output power may be defined as a loss value.

The larger the loss value, the lower the energy efficiency. In addition, electronic components of the coil driver circuit 10 may be damaged. Accordingly, the loss value requires to be minimized.

The controller 109 may control the inverter 130 to prevent the loss value from exceeding a predetermined value (3200).

Controlling the inverter 130 to prevent the loss value from exceeding the predetermined value may include adjusting an operating frequency of the inverter 130 or adjusting an operating duty ratio of the inverter 130 to prevent the loss value from exceeding the predetermined value.

That is, the controller 109 may adjust the operating frequency of the inverter 130 or the operating duty ratio of the inverter 130 to prevent the loss value from exceeding the predetermined value.

For example, the controller 109 may increase the operating frequency of the inverter 130 or reduce the operating duty ratio of the inverter 130 to prevent the loss value from exceeding the predetermined value.

In an embodiment, the controller 109 may adjust the operating frequency of the inverter 130 or the operating duty ratio of the inverter 130 to minimize the loss value.

According to the disclosure, the output power consumed by the working coil 200 may be accurately identified, and thus the working coil 200 may be driven with optimal energy efficiency.

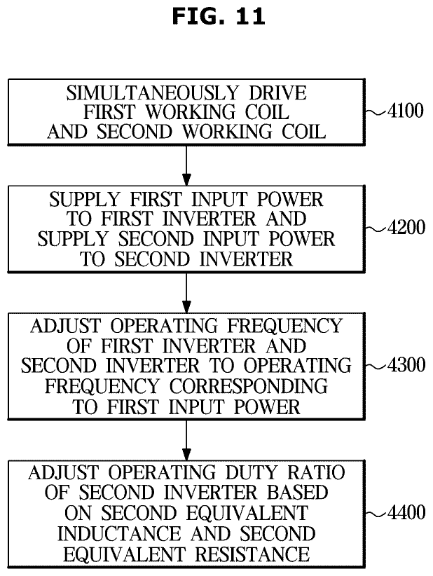

FIG. 11 is a flowchart illustrating a method for controlling a plurality of inverters to heat an object with maximum efficiency while minimizing noise generation, in a method for controlling a cooking apparatus according to an embodiment.

The cooking apparatus 1 may include a plurality of working coils 200.

The plurality of working coils 200 may include the first working coil 200 and the second working coil 200 adjacent to each other.

The first working coil 200 and the second working coil 200 may be the working coils (200a and 200b or 200L and 200H) of FIG. 1, or may be working coils adjacent to each other in the row direction or the column direction among the working coils shown in FIG. 2.

Here, the first working coil 200 may be driven by the first inverter 130, and the second working coil 200 may be driven by the second inverter 130.

The first inverter 130 and the second inverter 130 may be included in different coil driver circuits 10 or may be provided in the same coil driver circuit 10.

The controller 109 may drive the first working coil 200 and the second working coil 200 simultaneously (4100).

For example, in a case where the first working coil 200 and the second working coil 200 correspond to the working coils 200L and 200H of FIG. 1, respectively, the controller 109 may start driving the first working coil 200 and the second working coil 200 simultaneously in response to receiving a heating command for the first cooking zone 111.

In another example, in a case where the first working coil 200 and the second working coil 200 correspond to the working coils 200L and 200H of FIG. 1, respectively, the controller 109 may drive one of the first working coil 200L and the second working coil 200H in response to receiving a low heat level heating command for the first cooking zone 111, and the controller 109 may drive the other one of the first working coil 200L and the second working coil 200H in response to receiving a high heat level heating command for the first cooking zone 111, thereby simultaneously driving the first working coil 200L and the second working coil 200H.

In still another example, in a case where the first working coil 200 and the second working coil 200 correspond to the working coils 200a and 200b of FIG. 1, respectively, the controller 109 may drive the first working coil 200a in response to receiving a heating command for the second cooking zone 112, and the controller 109 may drive the second working coil 200b in response to receiving a heating command for the third cooking zone 113, thereby simultaneously driving the first working coil 200a and the second working coil 200b.

In yet another example, in a case where the first working coil 200 and the second working coil 200 are the adjacent working coils of FIG. 2, the controller 109 may simultaneously drive the adjacent working coils corresponding to an area where the object is placed.

Hereinafter, for convenience of description, the first working coil 200 is described as the first working coil 200a shown in FIG. 1 and the second working coil 200 is described as the second working coil 200b shown in FIG. 1. However, the description may be applied to all of the above-described examples.

The controller 109 may determine a first equivalent inductance and a first equivalent resistance of a first object heated by the first working coil 200a, based on a measurement value of the first current sensor 150 measuring a first resonant current flowing in the first working coil 200a.

The controller 109 may determine a second equivalent inductance and a second equivalent resistance of a second object heated by the second working coil 200b, based on a measurement value of the second current sensor 150 measuring a second resonant current flowing in the second working coil 200b.

The controller 109 may supply a first input power to the first inverter 130 based on a first heating intensity corresponding to the first working coil 200, and may supply a second input power to the second inverter 130 based on a second heating intensity corresponding to the second working coil 200 (4200).

The first heating intensity and the second heating intensity may be set by a user through the input device 104. In a case where the second heating intensity is set to be weaker than the first heating intensity, a second input power (e.g., 500 W) may be less than a first input power (e.g., 1000 W).

Meanwhile, an operating frequency corresponding to the first input power and an operating frequency corresponding to the second input power may be different from each other, and in a case where the first inverter 130 and the second inverter 130 are driven at different operating frequencies, a loud noise may occur.

In an embodiment, in a case where the first input power is supplied to the first inverter 130 and the second input power less than the first input power is supplied to the second inverter 130, the controller 109 may drive the first inverter 130 and the second inverter 130 at an operating frequency corresponding to the first input power (4300).

The operating frequency corresponding to the first input power may be calculated based on a magnitude of the first input power. The operating frequency corresponding to the first input power may correspond to a frequency of an AC power corresponding to the first input power.

Driving the first inverter 130 and the second inverter 130 at the operating frequency corresponding to the first input power may include setting both a frequency of an AC power supplied to the first inverter 130 and a frequency of an AC power supplied to the second inverter 130 to the frequency of the AC power corresponding to the first input power.

According to the disclosure, by matching the operating frequencies of the first inverter 130 and the second inverter 130 corresponding to the first working coil 200a and the second working coil 200b adjacent to each other, respectively, noise generated by the driving the first inverter 130 and the second inverter 130 may be suppressed.

Meanwhile, because the operating frequency of the second inverter 130 is set to the operating frequency corresponding to the first input power, the cooking apparatus 1 requires to adjust an operating duty ratio of the second inverter 130 to supply the second input power less than the first input power to the second inverter 130.

The controller 109 ascertains the operating frequency of the second inverter 130 and the second equivalent inductance and the second equivalent resistance of the second object.

In a case where the controller 109 ascertains the operating frequency of the second inverter 130 and the second equivalent inductance and the second equivalent resistance of the second object, the operating duty ratio of the second inverter 130 that makes the output power of the second working coil 200b become the second input power may be calculated.

In an embodiment, the controller 109 may adjust the operating duty ratio of the second inverter 130 based on the second equivalent inductance and the second equivalent resistance (4400).

For example, the controller 109 may determine a target duty ratio that makes the output power of the second working coil 200b become the second input power based on the second equivalent inductance and the second equivalent resistance, and may adjust the operating duty ratio of the second inverter 130 to the determined target duty ratio.

According to the disclosure, the cooking apparatus 1 may accurately identify the equivalent inductance and the equivalent resistance of the object heated by each of the plurality of coils, thereby determining the target duty ratio that allows the output power of the working coil 200 to correspond to the input power.

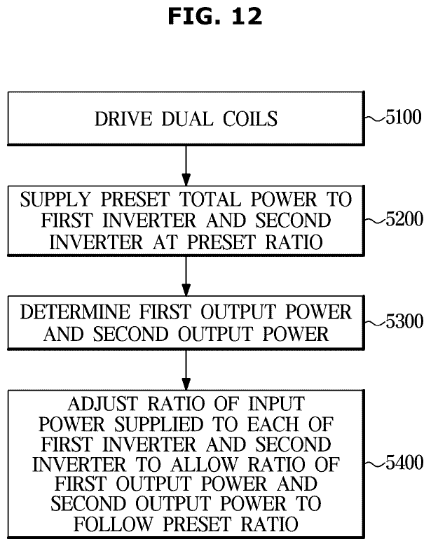

FIG. 12 is a flowchart illustrating a method for controlling a dual coil to heat an object with maximum efficiency, in a method for controlling a cooking apparatus according to an embodiment.

The cooking apparatus 1 may include a plurality of working coils 200.

The plurality of working coils 200 may include the dual coils (the first dual coil 200L and the second dual coil 200H) shown in FIG. 1.

The controller 109 may drive the working coils 200L and 200H in response to receiving a heating command for a cooking area in which the working coils 200L and 200H are arranged (5100).

The controller 109 may determine a total power (hereinafter, “preset total power”) applied to the working coils 200L and 200H based on a heating intensity corresponding to the heating command.

The controller 109 may supply the preset total power to the first inverter 130 and the second inverter 130 at a preset ratio (5200).

For example, in a case where a total power of 1000 W is supplied to the first inverter 130 and the second inverter 130 at a ratio of 3:7, an input power of the first inverter 130 may be set to 300 W and an input power of the second inverter 130 may be set to 700 W.

Here, the preset ratio is an optimal ratio for uniform heat distribution to an object ob, and may be preset through experiments when manufacturing the cooking apparatus 1.

In an embodiment, the working coils 200L and 200H may be provided in the same coil driver circuit 10.

In a case where the working coils 200L and 200H are provided in the same coil driver circuit 10, the inverter 130 of each of the working coils 200L and 200H are driven at the same operating frequency, and accordingly, the controller 109 may distribute the preset total power to each of the working coils 200L and 200H at the preset ratio by adjusting the operating duty ratio of the inverters 130.

For example, the controller 109 may supply the preset total power to the first inverter 130 and the second inverter 130 at the preset ratio, respectively, by controlling the operating duty ratio of the first inverter 130 driving the first working coil 200L and the operating duty ratio of the second inverter 130 driving the second working coil 200H.

In an embodiment, the working coils 200L and 200H may be provided in different coil driver circuits 10 (e.g., the first coil driver circuit 10-1 and the second coil driver circuit 10-2).

In a case where the working coils 200L and 200H are provided in different coil driver circuits 10, the controller 109 may distribute the preset total power to each of the working coils 200L and 200H at the preset ratio by controlling a frequency of an AC power applied to each of the working coils 200L and 200H.

For example, the controller 109 may supply the preset total power to the first inverter 130 and the second inverter 130 at the preset ratio, respectively, by controlling the operating duty ratio of the first inverter 130 driving the first working coil 200L and the operating duty ratio of the second inverter 130 driving the second working coil 200H.

The controller 109 may determine an equivalent resistance of a first object heated by the first working coil 200L and an equivalent resistance of a second object heated by the second working coil 200H. Here, the first object and the second object may be the same object, but the equivalent resistances of each of the first object and the second object may be different from each other depending on their positions on the corresponding working coils 200L and 200H.

As described above, the cooking apparatus 1 according to an embodiment of the disclosure may identify an output power consumed by each coil by measuring only a resonant current flowing in each working coil 200.

The controller 109 may determine a first output power consumed by the first working coil 200L based on an input voltage supplied to the first inverter 130 and the equivalent resistance of the first object heated by the first working coil 200L (5300).

The controller 109 may determine a second output power consumed by the second working coil 200H based on an input voltage supplied to the second inverter 130 and the equivalent resistance of the second object heated by the second working coil 200H (5300).

The controller 109 may adjust a ratio of the input power supplied to each of the first inverter 130 and the second inverter 130 to allow a ratio of the first output power and the second output power to follow a preset ratio (5400).

For example, the controller 109 may control the operating frequency and/or the operating duty ratio of the first inverter 130 and the second inverter 130 to allow the ratio of the first output power and the second output power to follow the ratio of the input power supplied to each of the first inverter 130 and the second inverter 130.

According to the disclosure, the cooking apparatus 1 may optimally heat the object ob based on the first output power actually consumed by the first working coil 200L and the second output power actually consumed by the second working coil 200H.

Meanwhile, by identifying the accurate equivalent inductance L_{eq*} and equivalent resistance R_{eq*} of the object ob, the cooking apparatus 1 may implement various embodiments in addition to the embodiments described above.

For example, because a temperature of the food inside the object ob increases, the equivalent inductance L_{eq*} and the equivalent resistance R_{eq*} of the object ob may change.

The controller 109 may identify the temperature of the food inside the object ob based on the equivalent inductance L_{eq*} and the equivalent resistance R_{eq*} of the object ob.

The controller 109 may perform various operations based on the identified temperature of the food inside the object ob.

For example, the controller 109 may notify a user that the identified temperature of the food exceeds a predetermined temperature, in response to the identified temperature of the food inside the object ob exceeding the predetermined temperature.

In another example, the controller 109 may automatically adjust a heating intensity of the working coil 200, in response to the identified temperature of the food inside the object ob exceeding the predetermined temperature.

According to an embodiment of the disclosure, a cooking apparatus 1 may include: a working coil 200; an inverter 130 configured to drive the working coil 200; a current sensor 150 configured to measure a resonant current flowing in the working coil 200; and a controller 109 configured to determine an equivalent inductance L_{eq*} of an object ob heated by the working coil 200 based on a magnitude of the resonant current Ir_sen measured by the current sensor 150, determine an equivalent resistance R_{eq*} of the object based on a phase of the resonant current Ir_sen measured by the current sensor 150 and the equivalent inductance L_{eq*}, and control the inverter 130 based on at least one of the equivalent inductance L_{eq*} or the equivalent resistance R_{eq*}.

The controller 109 may be configured to determine a reference resonant current I_{r*} based on an input voltage V_{DC} supplied to the inverter 130, a pre-stored reference inductance L_{ref}, a pre-stored reference resistance R_{ref}, and a pre-stored reference capacitance Cᵣ, and determine the equivalent inductance L_{eq*} based on a difference between a magnitude of the reference resonant current I_{r*} and the magnitude of the resonant current Ir_sen measured by the current sensor 150.

The controller 109 may be configured to determine a reference phase difference θ* based on the equivalent inductance L_{eq*}, the reference resistance R_{ref}, and the reference capacitance Cᵣ, and determine the equivalent resistance R_{eq*} based on a difference between the reference phase difference θ* and a phase difference θ_sen between a pole voltage of the inverter 130 and the resonant current.

The controller 109 may be configured to repeatedly perform an operation of determining the reference resonant current I_{r*}, an operation of determining the equivalent inductance L_{eq*}, an operation of determining the reference phase difference θ*, and an operation of determining the equivalent resistance R_{eq*} , using the equivalent inductance L_{eq*} and the equivalent resistance R_{eq*} as the reference inductance L_{ref} and the reference resistance R_{ref}, respectively.

The controller 109 may be configured to identify whether the object is a foreign substance based on the equivalent inductance L_{eq*}, and based on identifying that the object is the foreign substance, stop driving the inverter 130.

The controller 109 may be configured to determine an output power consumed by the working coil 200 based on an input voltage V_{DC} supplied to the inverter 130 and the equivalent resistance R_{eq*}, and control the inverter 130 to prevent a difference between an input power supplied to the inverter 130 and the output power from exceeding a defined value.

The controller 109 may be configured to adjust an operating frequency of the inverter 130 or adjust an operating duty ratio of the inverter 130 to prevent the difference between the input power and the output power from exceeding the defined value.

The working coil 200 may include a first working coil 200 and a second working coil 200, the inverter 130 may include a first inverter 130 configured to drive the first working coil 200 and a second inverter 130 configured to drive the second working coil 200, and the current sensor 150 may include a first current sensor 150 configured to measure a first resonant current flowing in the first working coil 200 and a second current sensor 150 configured to measure a second resonant current flowing in the second working coil 200. The controller 109 may be configured to determine a first equivalent inductance L_{eq*} and a first equivalent resistance R_{eq*} of a first object heated by the first working coil 200 based on a measured value of the first current sensor 150, and a second equivalent inductance L_{eq*} and a second equivalent resistance R_{eq*} of a second object heated by the second working coil 200 based on a measured value of the second current sensor 150.

The controller 109 may be configured to supply the first inverter 130 and the second inverter 130 with a preset total power corresponding to a preset output intensity at a preset ratio, determine a first output power based on a first input voltage supplied to the first inverter 130, the first equivalent inductance L_{eq*}, and the first equivalent resistance R_{eq*}, determine a second output power based on a second input voltage supplied to the second inverter 130, the second equivalent inductance L_{eq*}, and the second equivalent resistance R_{eq*}, and adjust a ratio of an input power supplied to each of the first inverter 130 and the second inverter 130 to allow a ratio of the first output power and the second output power to follow the preset ratio.

Based on a first input power being supplied to the first inverter 130 and a second input power less than the first input power being supplied to the second inverter 130, the controller 109 may be configured to drive the first inverter 130 and the second inverter 130 at an operating frequency corresponding to the first input power, and adjust an operating duty ratio of the second inverter 130 based on the second equivalent inductance L_{eq*} and the second equivalent resistance R_{eq*}.

According to an embodiment of the disclosure, in a method for controlling a cooking apparatus including a working coil 200, an inverter 130 configured to drive the working coil 200, and a current sensor 150 configured to measure a resonant current flowing in the working coil 200, the method may include: determining an equivalent inductance L_{eq*} of an object heated by the working coil 200 based on a magnitude of the resonant current Ir_sen measured by the current sensor 150; determining an equivalent resistance R_{eq*} of the object based on a phase of the resonant current Ir_sen measured by the current sensor 150 and the equivalent inductance L_{eq*}; and controlling the inverter 130 based on at least one of the equivalent inductance L_{eq*} or the equivalent resistance R_{eq*}.

The determining of the equivalent inductance L_{eq*} may include: determining a reference resonant current I_{r*} based on an input voltage V_{DC} supplied to the inverter 130, a pre-stored reference inductance L_{ref}, a pre-stored reference resistance R_{ref}, and a pre-stored reference capacitance Cᵣ, and determining the equivalent inductance L_{eq*} based on a difference between a magnitude of the reference resonant current I_{r*} and the magnitude of the resonant current I_{r_sen} measured by the current sensor 150.

The determining of the equivalent resistance R_{eq*} may include: determining a reference phase difference θ* based on the equivalent inductance L_{eq*} , the reference resistance R_{ref}, and the reference capacitance Cᵣ, and determining the equivalent resistance R_{eq*} based on a difference between the reference phase difference θ* and a phase difference θₛₑₙ between a pole voltage of the inverter 130 and the resonant current

The method may further include: repeatedly performing an operation of determining the reference resonant current I_{r*}, an operation of determining the equivalent inductance L_{eq*}, an operation of determining the reference phase difference θ*, and an operation of determining the equivalent resistance R_{eq*} , using the equivalent inductance L_{eq*} and the equivalent resistance R_{eq*} as the reference inductance L_{ref} and the reference resistance R_{ref}, respectively.

The controlling of the inverter 130 may include determining whether the object is a foreign substance based on the equivalent inductance L_{eq*}; and based on determining that the object is the foreign substance, stopping driving the inverter 130.

The controlling of the inverter 130 may include determining an output power consumed by the working coil 200 based on an input voltage supplied to the inverter 130 and the equivalent resistance R_{eq*}, and controlling the inverter 130 to prevent a difference between an input power supplied to the inverter 130 and the output power from exceeding a defined value.

The controlling of the inverter 130 may include adjusting an operating frequency of the inverter 130 or adjusting an operating duty ratio of the inverter 130 to prevent the difference between the input power and the output power from exceeding the defined value.

The working coil 200 may include a first working coil 200 and a second working coil 200, the inverter 130 may include a first inverter 130 configured to drive the first working coil 200 and a second inverter 130 configured to drive the second working coil 200, and the current sensor 150 may include a first current sensor 150 configured to measure a first resonant current flowing in the first working coil 200 and a second current sensor 150 configured to measure a second resonant current flowing in the second working coil 200. The determining of the equivalent inductance L_{eq*} may include: determining a first equivalent inductance L_{eq*} of a first object heated by the first working coil 200 based on a measured value of the first current sensor 150, and a second equivalent inductance L_{eq*} of a second object heated by the second working coil 200 based on a measured value of the second current sensor 150. The determining of the equivalent resistance R_{eq*} may include: determining a first equivalent resistance R_{eq*} of the first object heated by the first working coil 200 based on a measured value of the first current sensor 150, and a second equivalent resistance R_{eq*} of the second object heated by the second working coil 200 based on a measured value of the second current sensor 150.

The controlling of the inverter 130 may include: supplying the first inverter 130 and the second inverter 130 with a preset total power corresponding to a preset output intensity at a preset ratio, determining a first output power based on a first input voltage supplied to the first inverter 130, the first equivalent inductance L_{eq*}, and the first equivalent resistance R_{eq*} , determining a second output power based on a second input voltage supplied to the second inverter 130, the second equivalent inductance L_{eq*}, and the second equivalent resistance R_{eq*} , and adjusting a ratio of an input power supplied to each of the first inverter 130 and the second inverter 130 to allow a ratio of the first output power and the second output power to follow the preset ratio.

Based on a first input power being supplied to the first inverter 130 and a second input power less than the first input power being supplied to the second inverter 130, the controlling of the inverter 130 may include driving the first inverter 130 and the second inverter 130 at an operating frequency corresponding to the first input power, and adjusting an operating duty ratio of the second inverter 130 based on the second equivalent inductance L_{eq*} and the second equivalent resistance R_{eq*}/

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

Also, the computer-readable recording medium may be provided in the form of a non-transitory storage medium. Here, when a storage medium is referred to as “non-transitory,” it may be understood that the storage medium is tangible and does not include a signal (electromagnetic waves), but rather that data is semi-permanently or temporarily stored in the storage medium. For example, a “non-transitory storage medium” may include a buffer in which data is temporarily stored.

The methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

1. A cooking apparatus, comprising:
a working coil;
an inverter configured to drive the working coil;
a current sensor configured to measure a resonant current flowing in the working coil as the working coil is driven by the inverter; and
a controller configured to
determine an equivalent inductance of an object heatable by the working coil while the object is above the working coil based on a magnitude of the resonant current measured by the current sensor,
determine an equivalent resistance of the object based on a phase of the resonant current measured by the current sensor and the equivalent inductance, and
control driving of the working coil by the inverter based on the equivalent inductance of the object, or based on the equivalent resistance of the object, or based on the equivalent inductance of the object and the equivalent resistance of the object.

2. The cooking apparatus of claim 1, wherein the controller is configured to:
determine a reference resonant current based on an input voltage supplied to the inverter, a pre-stored reference inductance, a pre-stored reference resistance, and a pre-stored reference capacitance, and
determine the equivalent inductance based on a difference between a magnitude of the reference resonant current and the magnitude of the resonant current measured by the current sensor.

3. The cooking apparatus of claim 2, wherein the controller is configured to:
determine a reference phase difference based on the equivalent inductance, the reference resistance, and the reference capacitance, and
determine the equivalent resistance based on a difference between the reference phase difference and a phase difference between a pole voltage of the inverter and the resonant current.

4. The cooking apparatus of claim 3, wherein the controller is configured to repeatedly perform
a determination of the reference resonant current,
a determination of the equivalent inductance,
a determination of the reference phase difference, and
a determination of the equivalent resistance,
wherein subsequent determinations use the equivalent inductance from a previous determination as the reference inductance, and the equivalent resistance from a previous determination as the reference resistance.

5. The cooking apparatus of claim 1, wherein the controller is configured to
identify whether the object is a foreign substance not intended to be heated based on the equivalent inductance, and
based on identifying that the object is the foreign substance, stop driving the inverter.

6. The cooking apparatus of claim 1, wherein the controller is configured to
determine an output power consumed by the working coil based on an input voltage supplied to the inverter and the equivalent resistance, and
control the inverter to prevent a difference between an input power supplied to the inverter and the output power from exceeding a defined value.

7. The cooking apparatus of claim 6, wherein the controller is configured to adjust an operating frequency of the inverter or adjust an operating duty ratio of the inverter to prevent the difference between the input power and the output power from exceeding the defined value.

8. The cooking apparatus of claim 1, wherein
the working coil is a first working coil,
the inverter is a first inverter configured to drive the first working coil,
the current sensor is a first current sensor configured to measure a first resonant current flowing in the first working coil, and
the cooking apparatus further comprises:
a second working coil;
a second inverter configured to drive the second working coil; and
a second current sensor configured to measure a second resonant current flowing in the second working coil;
wherein the controller is configured to determine
a first equivalent inductance of a first object heatable by the first working coil while the first object is above the first working coil based on a measured value of the first current sensor,
a first equivalent resistance of the first object based on the measured value of the first current sensor,
a second equivalent inductance of a second object heatable by the second working coil while the second object is above the second working coil based on a measured value of the second current sensor, and
a second equivalent resistance of the second object based on the measured value of the second current sensor.

9. The cooking apparatus of claim 8, wherein the controller is configured to:
supply the first inverter and the second inverter together with a preset total power corresponding to a preset output intensity, and
distribute the preset total power between the first inverter and the second inverter at a preset ratio by,
determining a first output power based on a first input voltage supplied to the first inverter, the first equivalent inductance, and the first equivalent resistance,
determining a second output power based on a second input voltage supplied to the second inverter, the second equivalent inductance, and the second equivalent resistance, and
adjusting a ratio of an input power supplied to each of the first inverter and the second inverter to allow a ratio of the first output power and the second output power to follow the preset ratio.

10. The cooking apparatus of claim 8, wherein, based on a first input power being supplied to the first inverter and a second input power less than the first input power being supplied to the second inverter, the controller is configured to:
drive the first inverter and the second inverter at an operating frequency corresponding to the first input power, and
adjust an operating duty ratio of the second inverter based on the second equivalent inductance and the second equivalent resistance.

11. A method for controlling a cooking apparatus including a working coil, an inverter configured to drive the working coil, and a current sensor configured to measure a resonant current flowing in the working coil as the working coil is driven by the inverter, the method comprising:
determining an equivalent inductance of an object heatable by the working coil while the object is above the working coil based on a magnitude of the resonant current measured by the current sensor;
determining an equivalent resistance of the object based on a phase of the resonant current measured by the current sensor and the equivalent inductance; and
controlling the driving of the working coil by the inverter based on the equivalent inductance of the object, or based on the equivalent resistance of the object, or based on the equivalent inductance of the object and the equivalent resistance of the object.

12. The method of claim 11, wherein the determining of the equivalent inductance includes:
determining a reference resonant current based on an input voltage supplied to the inverter, a pre-stored reference inductance, a pre-stored reference resistance, and a pre-stored reference capacitance, and
determining the equivalent inductance based on a difference between a magnitude of the reference resonant current and the magnitude of the resonant current measured by the current sensor.

13. The method of claim 12, wherein the determining of the equivalent resistance includes:
determining a reference phase difference based on the equivalent inductance, the reference resistance, and the reference capacitance, and
determining the equivalent resistance based on a difference between the reference phase difference and a phase difference between a pole voltage of the inverter and the resonant current.

14. The method of claim 13, further comprising:
repeatedly perform a determination of the reference resonant current, a determination of the equivalent inductance, a determination of the reference phase difference, and a determination of the equivalent resistance, for subsequent determinations using the equivalent inductance from a previous determination as the pre-stored reference inductance and the equivalent resistance from a previous determination as the reference resistance.

15. The method of claim 11, wherein the controlling of the inverter includes
determining whether the object is a foreign substance not intended to be heated based on the equivalent inductance; and
based on determining that the object is the foreign substance, stopping driving the inverter.
